(19) United States
(12) Patent Application Publication
(10) Pub. No.: US 2009/0283179 A1
(43) Pub. Date: Nov. 19, 2009

(54) WATER DISPENSER

(75) Inventor: Derek James Black, York (GB)

Correspondence Address: BROOKS KUSHMAN P.C., 1000 TOWN CENTER, TWENTY-SECOND FLOOR, SOUTHFIELD, MI, 48075, US

(73) Assignee: CRANSWICK PET AND AQUATICS PLC, Kingston Upon Hull (GB)

(21) Appl. No.: 12/122,054

(22) Filed: May 16, 2008

(51) Int. Cl. B67C 3/00

(52) U.S. Cl. 141/358

(57) ABSTRACT

A water dispenser comprising a vessel (1) having an open mouth (4) at one end which is adapted in use to be filled with water, and a base unit (2) having side walls (5) and a bottom (6) to form an open topped reservoir, connection means (8, 9; 12) for connecting the open mouth of the vessel (1) to the base unit (2) such that on inversion water is able to flow from the vessel (1) into the open topped reservoir, and a plurality of watering stations (3) in the side walls (5) of the base unit (2), each of which watering stations (3) communicates with the open topped reservoir via a respective opening in the side wall (5).

### BACKGROUND OF THE INVENTION

1. Field of the Invention

The present invention relates to a water dispenser for animals. More specifically the present invention relates to a water dispenser having a plurality of drinking stations.

2. Background Art

It is well known to provide bird baths in gardens and courtyards for wild birds to drink from and bathe in. Water is not always easily accessible to birds and providing a source of water in the garden is an effective way of attracting them in. A typical bird bath comprises a shallow tray or saucer which is elevated above the ground. Unfortunately, because birds make no distinction between water for bathing in and water for drinking, the water in a bird bath can easily become dirty and contaminated. Not only is this aesthetically unattractive, but it may represent a health hazard to birds visiting the bird bath.

### SUMMARY OF THE INVENTION

It is an object of the present invention to provide a water dispenser which dispenses water to a plurality of drinking stations.

It is another object of the present invention to provide a water dispenser comprising a reservoir of water which is largely inaccessible, thus preventing birds from bathing in it and thereby minimising contamination of the water.

According to the present invention there is provided a water dispenser comprising a vessel having an open mouth at one end which is adapted in use to be filled with water, and a base unit having side walls and a bottom to form an open topped reservoir, connection means for connecting the open mouth of the vessel to the base unit such that on inversion water is able to flow from the vessel into the open topped reservoir, and a plurality of watering stations in the side walls of the base unit, each of which watering stations is connected to the open topped reservoir via a respective opening in the side wall.

In a preferred embodiment of the present invention the vessel takes the form of a bottle and the base unit comprises a tubular connection which extends upwardly from the bottom of the base unit and which has openings in the side thereof. The upper end of the tubular connection is adapted to engage with and connect to the mouth of the bottle. On inversion water flows from the bottle, through the openings in the side of the tubular connection and into the open topped reservoir.

Preferably, the water dispenser further comprises a hanger which enables the water dispenser to be suspended in position. Conveniently, the hanger takes the form of a wire which is connected at each end to a respective side of the base unit and which forms a loop above the bottle. In a preferred embodiment of the present invention a cap is supported between opposite sides of the wire below the loop and is slidable into engagement with the base of the bottle.

Conveniently, the mouth of the bottle and the bottle engaging means are each provided with complimentary screw threads.

Preferably, each of the watering stations takes the form of an open bowl-shaped protrusion from the side wall of the base unit.

In use, the vessel is filled with water and the base unit is attached to it. The vessel with the base unit attached to it is then inverted. Water flows from the vessel into the base unit to fill the reservoir up to the level of the watering stations provided in the side walls thereof. As water is removed from the reservoir by birds drinking at the drinking stations the water level in the reservoir falls to the point where air can enter the bottle. This allows water to flow from the vessel and re-fill the reservoir to the level of the watering stations. This is repeated until the water level in the vessel falls to the same level as the water in the reservoir. Water is prevented from pouring out of the vessel once inverted by the negative pressure behind the water in the vessel.

By making the drinking stations big enough for a bird to drink from, but too small for a bird to bathe in, contamination of water in the reservoir is minimised. This helps to keep the bird dispenser clean which safeguards against the transmission of diseases between birds using the water dispenser and reduces the amount of cleaning which must be carried out by the person putting out water for the birds.

### BRIEF DESCRIPTION OF THE DRAWINGS

Embodiments of the present invention will now be described, by way of example, with reference to the accompanying drawings, in which:

FIG. 1 shows an embodiment of a water dispenser according to the present invention;

FIG. 2 shows the refillable bottle of the water dispenser shown in FIG. 1;

FIG. 3 shows a perspective view of the base unit of the water dispenser shown in FIG. 1;

FIG. 4 shows a sectional view of the base unit shown in FIG. 3; and

FIG. 5 shows a sectional view of the base unit of another embodiment of a water dispenser according to the present invention.

### DETAILED DESCRIPTION OF THE PREFERRED EMBODIMENT(S)

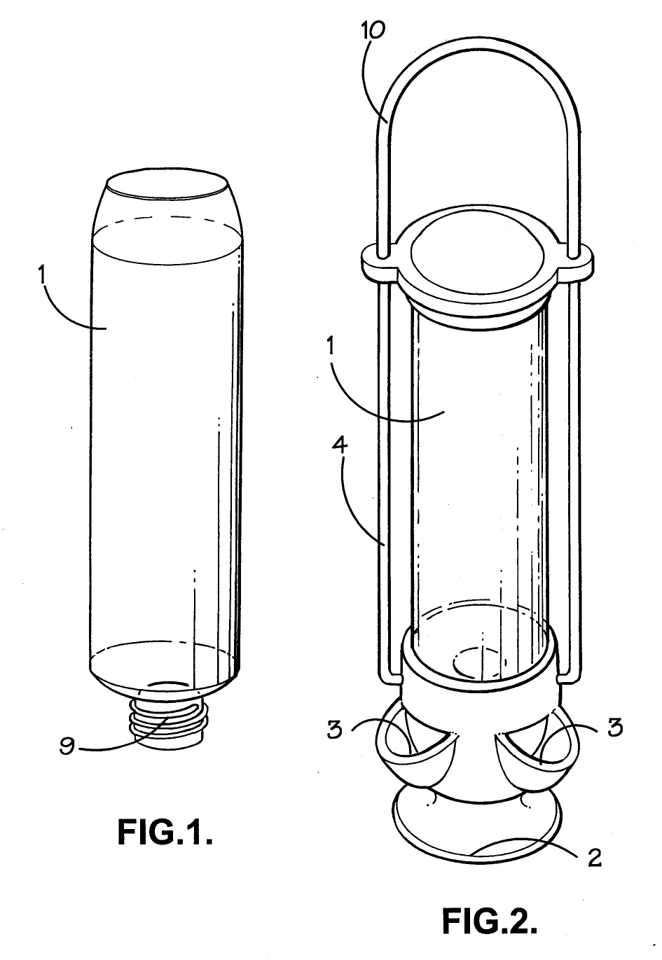

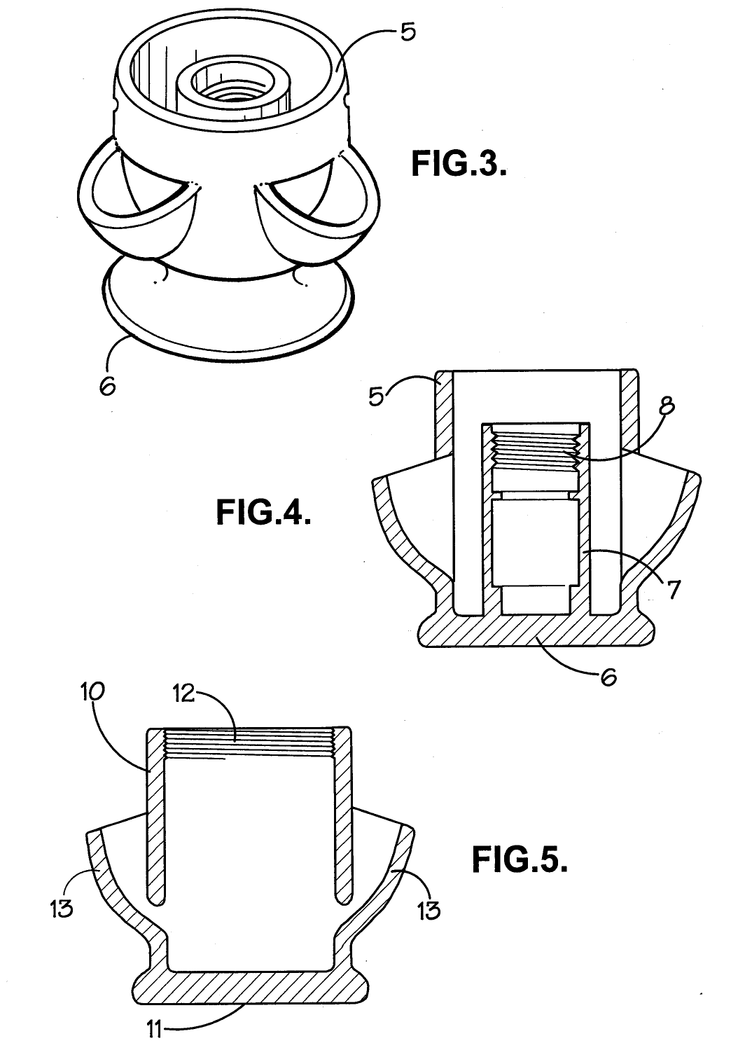

Referring to FIGS. 1 to 4 of the accompanying drawings there is shown a water dispenser comprising an inverted bottle 1 for containing a supply of water, a base unit 2 which defines three separate drinking stations 3 (only two of which are visible in the accompanying drawings) and a hanger 4. In use, the water dispenser is intended to be suspended from a hanger, a bird table, a tree or the like by means of the hanger 4 so as to be accessible to wild birds.

As shown in FIG. 4 the base unit 2 comprises an essentially cylindrical side wall 5 and a bottom 6 which together define an open topped reservoir. The open mouth of the reservoir is of essentially the same diameter as the bottle 1 which ensures that the shoulder of the bottle 1 is closely received between and supported on the side wall 5 of the base unit 2. Extending upwardly from the centre of the bottom 6 of the base unit 2 is a tubular connection or pipe 7. The upper end of the pipe 7 includes a screw threaded portion 8 to engage with a complimentary screwed threaded portion 9 on the mouth of the bottle 1 which is best seen in FIG. 2. Openings (not shown) are provided in the side of the pipe 7 to allow water in the bottle 1 to flow out into the reservoir formed between the side wall 5 and the bottom 6 of the base unit 2. The drinking stations 3 each take the form of an open bowl shaped protrusion from the side wall of the base unit. Each drinking station 3 is open to the reservoir through an opening in the side wall 5 so that it is filled with water therefrom.

The hanger 4 takes the form of a wire which is connected at each end to opposite sides of the base unit 2. The wire extends up each side of the bottle 1 and forms a loop above the base of the bottle 1 from which the water dispenser can be suspended. A cap 10 is connected between the two sides of the wire below the loop and is slidable on the wire into and out of engagement with the base of the bottle 1. This arrangement helps to secure the bottle 1 in place on the base unit 2.

In use, the bottle 1 is filled with water. The base unit 2 is then attached to it by screwing the screw threaded portion 8 of the pipe 7 onto screw threaded portion 9 of the mouth of the bottle 1. The bottle 1 with the base unit 2 attached to it is then inverted. Water flows from the bottle 1 through the openings in the upwardly extending pipe 6 to fill the reservoir up to the level of the watering stations 3 provided in the side wall thereof. As water is removed from the reservoir by birds drinking at the drinking stations 3 the water level in the reservoir falls to the point where air can enter the bottle 1. This equalises the pressure behind the water held in the bottle 1 and allows water to flow in to re-fill the reservoir to the level of the watering stations 3. This is repeated until the water level in the bottle 1 falls to the same level as the water in the reservoir.

Referring now to FIG. 5 there is shown the base unit of another embodiment of a water dispenser according to the present invention. The base unit comprises an essentially cylindrical side wall 10 and a bottom 11 which together define an open topped reservoir. Just inside the mouth of the reservoir a screw thread 12 is formed in the side wall 10. The screw thread 12 is adapted to engage with the screw threaded mouth of a jar, not shown. Drinking stations 13 in the form of an open bowl protrude from the side wall 10 of the base unit. Each drinking station 13 is open to the reservoir through a small opening 14 in the side wall 5 located towards the bottom of the drinking station. The small opening 14 between each drinking station 13 and the reservoir serves to regulate the rate at which water flows into the drinking stations 13. This helps to prevent water spilling out of the drinking stations as the water dispenser is inverted.

The base unit is manufactured from a single metal casting. By making the base unit from metal, the centre of gravity of the water feeder is lowered and the weight of the water feeder increased, which can help to stabilise it, especially where it is suspended from its hook, or placed on a horizontal surface. The vessel may comprise a plastics bottle and is preferably manufactured of a transparent material, such as plastics or glass, so that the level of water therein can be easily ascertained by external visual inspection.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A water dispenser comprising a vessel having an open mouth at one end which is adapted in use to be filled with water, and a base unit having side walls and a bottom to form an open topped reservoir, connection means for connecting the open mouth of the vessel to the base unit such that on inversion water is able to flow from the vessel into the open topped reservoir, and a plurality of watering stations in the side walls of the base unit, each of which watering stations communicates with the open topped reservoir via a respective opening in the side wall.

2. A water dispenser as claimed in claim 1, wherein the vessel comprises a bottle.

3. A water dispenser as claimed in claim 1, wherein the base unit comprises an essentially cylindrical side wall and a bottom which together define an open topped reservoir, the side wall comprising a screw thread located inside the mouth of the reservoir, the screw thread being adapted to engage with the screw threaded mouth of a jar or bottle.

4. A water dispenser as claimed in claim 1, wherein the base unit comprises a tubular connection for connection to a bottle, which extends upwardly from the bottom of the base unit and which has openings in the side thereof.

5. A water dispenser as claimed in claim 4, wherein the mouth of the bottle and the tubular connection are each provided with complimentary screw threads.

6. A water dispenser as claimed in claim 4, further comprising openings in the side of the pipe to allow water in the bottle to flow out into the reservoir.

7. A water dispenser as claimed in claim 1, wherein each of the watering stations takes the form of an open bowl-shaped protrusion from the side wall of the base unit.

8. A water dispenser as claimed in claim 1, wherein the watering stations protrude from the side wall of the base unit and are open to the reservoir through a small opening in the side wall of the base located towards the bottom of the watering station.

9. A water dispenser as claimed in claim 1, wherein water is prevented from pouring out of the vessel once inverted by the negative pressure behind the water in the vessel.

10. A water dispenser as claimed in claim 1, comprising three separate drinking stations.

11. A water dispenser as claimed in claim 1, comprising four separate drinking stations.

12. A water dispenser as claimed in claim 1, wherein the drinking are stations big enough for a bird to drink from, but too small for a bird to bathe in.

13. A water dispenser as claimed in claim 1, further comprising a hanger to enable the water dispenser to be suspended in position.

14. A water dispenser as claimed in claim 13, wherein the hanger comprises a wire which is connected at each end to opposite sides of the base unit.

15. A water dispenser as claimed in claim 14, wherein the wire extends up each side of the vessel and forms a loop above the base of the vessel from which the water dispenser can be suspended.

16. A water dispenser as claimed in claim 15, further comprising a cap connectable between the two sides of the wire below the loop, the cap being slidable on the wire into and out of engagement with the base of the bottle.

17. A water dispenser as claimed in claim 1, wherein in use, the vessel is fillable with water and the base unit attachable thereto, the vessel with the base unit attached to it being invertable such that water flows from the vessel to fill the reservoir up to the level of the watering stations, and, as water is removed from the reservoir by birds drinking at the drinking stations, the water level in the reservoir falls to the point where air can enter the vessel to equalise the pressure behind the water held in the bottle and to allow water to flow in to re-fill the reservoir to the level of the watering stations.

18. A water dispenser as claimed in claim 1, wherein the base unit comprises cast metal.

19. A water dispenser as claimed in claim 1, wherein the vessel comprises a plastics bottle.

20. A water dispenser as claimed in claim 1, wherein the vessel is transparent.
